(19) United States
(12) Patent Application Publication
(10) Pub. No.: US 2012/0105391 A1
(43) Pub. Date: May 3, 2012

(54) DRIVING CIRCUIT FOR A THREE-DIMENSIONAL LIQUID CRYSTAL LENS

(75) Inventors: Kuo-Chen TSAI, Hsinchu City (TW); Chih-Hao CHEN, New Taipei CIty (TW)

(73) Assignee: Richtek Technology Corporation, ChuPei City (TW)

(21) Appl. No.: 13/244,525

(22) Filed: Sep. 25, 2011

(30) Foreign Application Priority Data
Oct. 27, 2010 (TW) 099220798

(51) Int. Cl. G09G 5/00; G09G 3/36

(52) U.S. Cl. 345/204; 345/87

(57) ABSTRACT

A driving circuit for a three-dimensional liquid crystal lens provides a storage to store a high output value and a low output value of the channel output signal; the high and low output values are converted by a digital analog converter as the high output signal, the low output signal and the common signal which are driven by the driving circuit to produce the high driven output signal, the low driven output signal and the common output signal which are selectively output by the select logic circuit as the channel output signal according to the select signal; Thus, less operation amplifiers are needed, and the speed of response of the circuit can be enhanced. Power consumption can be reduced as well.

### BACKGROUND OF THE INVENTION

1. Field of the Invention

The present invention is related to a three-dimensional (3D) liquid crystal lens, and particularly to a driving circuit for a 3D liquid crystal lens.

2. Brief Description of the Related Art

The image display technology keeps progressing for pursuing acousto-optical needs of consumers. Due to the initial technique of two dimensional (2D) plane display being impossible to satisfy sensory organs of people, the technique of three-dimensional (3D) display recently has become the mainstream technique related to the image display.

A 3D liquid crystal lens in the three-dimensional display technique is a display technique capable of switching 2D images shown on the liquid crystal panel to 3D images, and vice versa. The application circuit of the 3D liquid crystal lens is illustrated in FIG. 1. A driving circuit 11 of the 3D liquid crystal lens is capable of driving and outputting wave shape signals varying between a high output value VH and a low output value VL as shown in FIG. 2 according to a select signal Bank_Sel output by a timing controller 12. For instance, 16 channel output signals OUT1˜OUT16 and 1 common output signal Vcom for driving 3D liquid crystal lens 13 to display 2D or 3D images.

Referring to FIG. 3, the conventional driving circuit of the 3D liquid crystal lens is illustrated. The data register 31 has two memory banks, hank A and bank B, stores high output values VH and low output values VL of 16 output signals OUT1˜OUT16, and the high output values VH and low output values VL are selectively sent out to the digital-analog converter 32 via the select signal Bank-Sel. The digital-analog converter 32 performs digital-analog conversions for the data of the high output values VH and the low output values VL, and outputs the channel signals Vref1˜Vref16 and a common signal Vrefcom. The output channel signals Vref1˜Vref16 and the common signal Vrefcom are driven by operation amplifiers 301˜317 respectively, and the channel output signals OUT1˜OUT16 and the common output signal Vcom are output via the operation amplifiers 301˜317.

The digital-analog converter 32 in the preceding way is capable of performing the digital-analog conversion and outputting the channel signals Vref1˜Vref16 and the common signal Vrefcom only after the selected data is output to the digital-analog converter 32 by the select signal Bank-Sel such that the speed of response becomes restricted. Besides, each of the channel output signals has to be driven by an operation amplifier to result in greatly increasing the area occupied in the integrated circuit. Generally, operational amplifiers consume more static quiescent power.

### SUMMARY OF THE INVENTION

Accordingly, an object of the present invention is to provide a driving circuit for a 3D liquid crystal lens with which a faster speed of response and an economical production cost can be obtained advantageously.

In order to achieve the preceding object, the driving circuit for a 3D liquid crystal lens according to the present invention creates multiple channel output signals and a common output signal in accordance with a select signal; the driving circuit for a 3D liquid crystal lens comprises a storage such as the data register, a digital-analog converter, a driving circuit and a select logic circuit.

Wherein, the storage is utilized to store a high output value and a low output value of the channel output signals for driving the 3D liquid crystal lens and a common output value so as to be converted and produced the high output signal, the low output signal and the common signal by the digital-analog converter. The driving circuit couples with the digital-analog converter for driving the said high output signal, low output signal and common signal to produce the high driven output signal, low driven output signal and common output signal. The select logic circuit couples with the driving circuit for selectively outputting the high driven output signal and the low driven output signal as the channel output signals according to the select signal.

In a preferred embodiment of the present invention, the select logic circuit of the driving circuit for a 3D liquid crystal lens includes multiple switch pairs and a logic controller; the multiple switch pairs are employed to output the high driven output signal or low driven output signal created by the driving circuit; the logic controller couples with the switch pairs for controlling “ON” and “OFF” of the switch pairs based on the select signal. Wherein, each of the preceding switch pairs consist of a PMOS transistor and a NMOS transistor, or other switch components such as the bipolar junction transistors (BJT) instead.

In a preferred embodiment of the present invention, the logic controller of the driving circuit for a 3D liquid crystal lens is further capable of referencing channel enabling data stored in the storage to decide if control of “ON” or “OFF” of the switch pairs is enabled.

In a preferred embodiment of the present invention, the driving circuit of the driving circuit for a 3D liquid crystal lens consists of three operation amplifiers which are employed to drive the high output signal, low output signal and common signal respectively.

From the foregoing, the driving circuit for the 3D liquid crystal lens according to the present invention provides the digital-analog converter to convert and produce the high output signal, low output signal and common signal, and the converting and producing operation is not performed after the select signal is chosen such that it is able to increase the speed of response without being restricted by the digital-analog converter. In addition, due to the channel output signal being created by means of the select logic circuit selectively outputting the high driven output signal and low driven output signal sent out from the driving circuit, only two operation amplifiers are required to drive and produce the needed high driven output signal and low driven output signal such that the operation amplifiers corresponding to multiple channels can be saved and the space occupied by the integrated circuit can be reduced tremendously to lower the production cost of the driving circuit of the 3D liquid crystal lens. The overall static quiescent current is reduced much as well.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a schematic diagram illustrating an conventional application circuit of the 3D liquid crystal lens;

FIG. 2 is an output wave-form of the driving circuit of the 3D liquid crystal lens shown in FIG. 1;

FIG. 3 is a schematic circuit diagram illustrating the conventional driving circuit of a 3D liquid crystal lens;

FIG. 4 is a schematic circuit diagram illustrating a driving circuit of a 3D liquid crystal lens according to a preferred embodiment of the present invention.

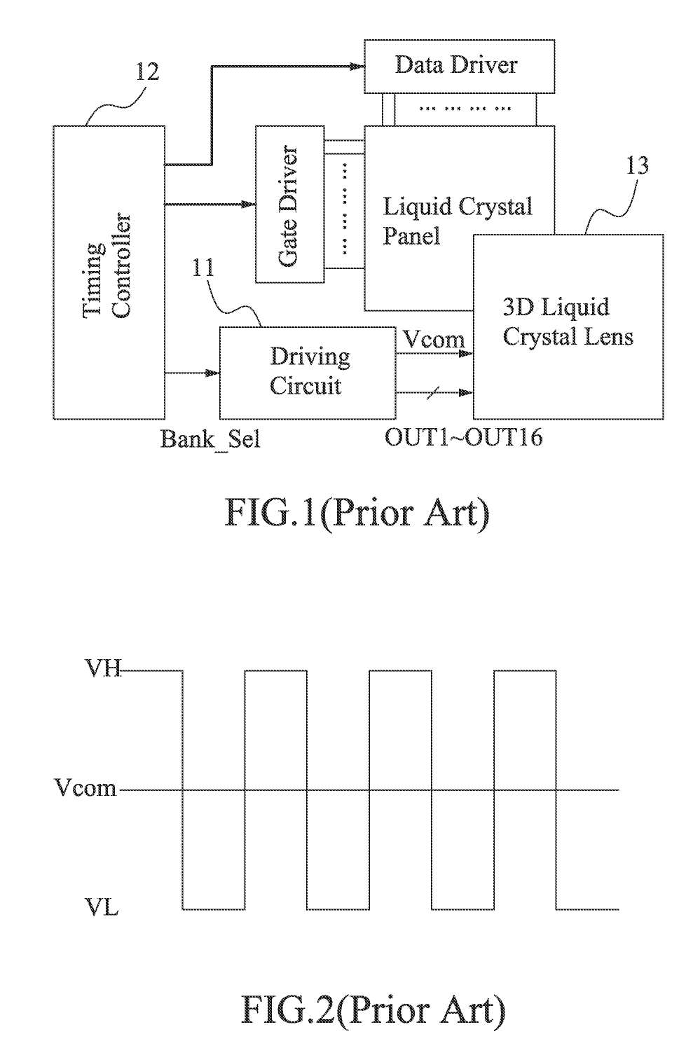

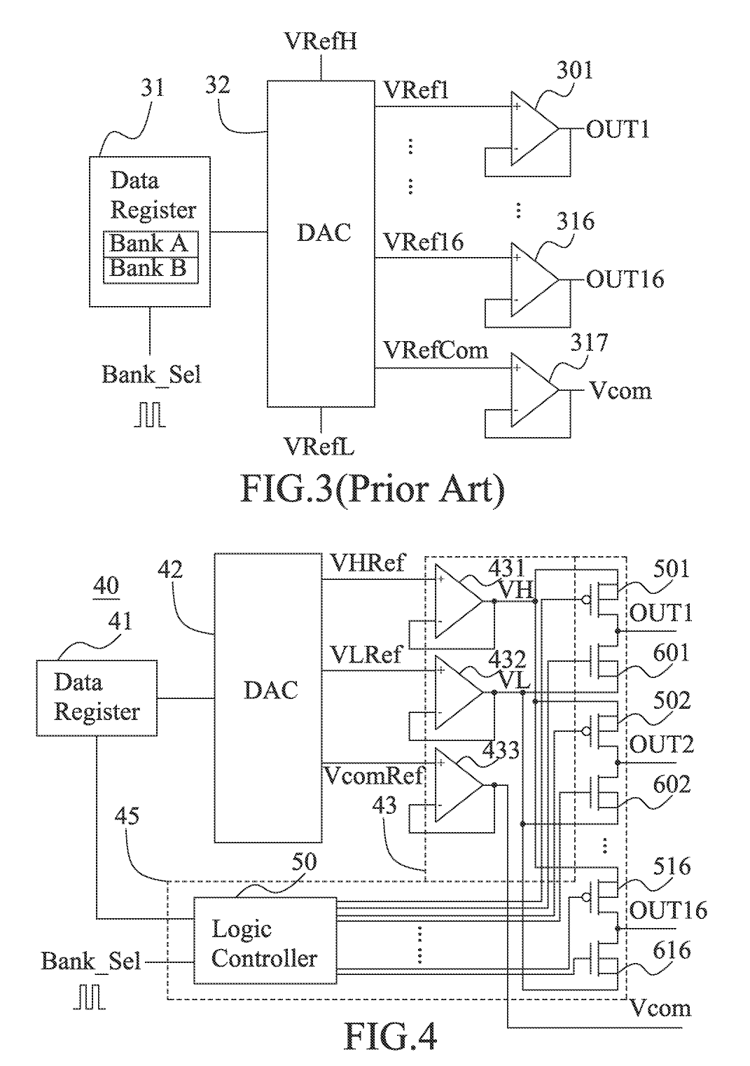

### DETAILED DESCRIPTION OF THE INVENTION

Referring to FIG. 4, the preferred embodiment of a driving circuit for a 3D liquid crystal lens according to the present invention is illustrated. The driving circuit 40 is suitable for producing multiple channel output signals OUT1˜OUT16 and a common output signal Vcom based on a select signal Bank_Sel.

The driving circuit 40 for a 3D liquid crystal lens as shown in FIG. 4 includes a storage 41 such as a data register, a digital analog converter (DAC) 42, a driving circuit 43 composed of three operation amplifiers 431, 432, 433 which are used for driving a high output signal VHRef, a low output signal VLRef and a common signal VcomRef, and a select logic circuit 45 composed of multiple switch pairs and a logic controller 50. Wherein, the multiple switch pairs consist of PMOS (P-Metal-Oxide-Semiconductor) transistors 501˜516 and NMOS (N-Metal-Oxide-Semiconductor) transistors 601˜616. Of course, other switch components such as BJT (Bipolar Junction Transistors) can be used as the multiple switch pairs instead for persons who are skillful in the art.

The data register 41 stores a high output value and a low output value of the channel output signals OUT1˜OUT16 and a common output value, and the DAC 42 is coupled to the data register 41 such that the high output value, the low output value and the common output value can be output to the digital analog converter 42 for being converted to analog values from digital values, and the high output signal VHRef, the low output signal VLRef and the common signal VcomRef are created.

The operation amplifiers 431, 432, 433 couple with the digital analog converter 42 to receive and drive the high output signal VHRef, the low output signal VLRef and the common signal VcomRef sent out from the digital analog converter 42 to produce a high driven output signal VH, a low driven output signal VL and the common output signal Vcom. Wherein, the high driven output signal VH and the low driven output signal VL are transmitted to the switch pairs consisting of the PMOS transistors 501˜516 and NMOS transistors 601˜616 respectively such that the high driven output signal VH and the low driven output signal VL can be selectively output as the channel output signals OUT1˜OUT16.

Wherein, when the high driven output signal VH is ready to be output as one of the channel output signals OUT1-OUT16, the logic controller 50 controls the PMOS transistors 501˜516 corresponding to the channels to be “ON” and the NMOS transistors 601˜616 corresponding to the channels to be “OFF” according to the select signal Bank_Sel. Contrarily, when the low driven output signal VL is ready to be output as one of the channel output signals OUT1-OUT16, the logic controller 50 controls the PMOS transistors 501˜516 corresponding to the channel to be “OFF” and the NMOS transistors 601˜616 corresponding to the channel to be “ON”.

Besides, the logic controller 50 is capable of further referencing channel enabling data saved in the data register 41 to decide if controls of “ON” or “OFF” of the PMOS transistors 501˜516 and the NMOS transistors 601˜616 are enabled for achieving the function of enabling outputs of the channel output signals OUT1˜OUT16.

It is noted that the preceding embodiment of the driving circuit 40 for a 3D liquid crystal lens takes 16 channels as an example, and 14 operation amplifiers, which are utilized in the prior art, can be saved without using. Thus, there are n−2 operation amplifiers can be saved for a driving circuit with n channels, that is, the number of the operation amplifiers keeps the same without change in spite of the number of the channels increasing. Therefore, the space occupied by the integrated circuit and the production cost can be reduced tremendously. For hand-held device, less number of operational amplifiers make high duration of battery life.

While the invention has been described with referencing to a preferred embodiment thereof, it is to be understood that modifications or variations may be easily made without departing from the spirit of this invention, which is defined by the appended claims.

What is claimed is:

1. A driving circuit for a three-dimensional liquid crystal lens, which is suitable for creating multiple channel output signals and a common output signal according to a select signal, comprising:
a storage for storing a high output value, a low output value and a common output value;
a digital analog converter coupling with the storage for converting and producing a high output signal, a low output signal and a common signal according to the high output value, the low output value and the common output value;
a driving circuit coupling with the digital analog converter for driving the high output signal, the low output signal and the common signal to produce a high driven output signal, a low driven output signal and the common output signal;
a select logic circuit coupling with the driving circuit for selectively outputting the high driven output signal and the low driven output signal as the channel output signals according to the select signal.

2. The driving circuit for a three-dimensional liquid crystal lens as defined in claim 1, wherein the select logic circuit further comprises:
a plurality of switch pairs to output the high driven output signal and the low driven output signal;
a logic controller coupling with the switch pairs to control ON and OFF of the switch pairs according to the select signal.

3. The driving circuit for a three-dimensional liquid crystal lens as defined in claim 2, wherein each of the switch pairs consists of a PMOS transistor and a NMOS transistor respectively.

4. The driving circuit for a three-dimensional liquid crystal lens as defined in claim 2, wherein each of the switch pairs consists of a bipolar junction transistor (BJT).

5. The driving circuit for a three-dimensional liquid crystal lens as defined in claim 2, wherein the logic controller decides if control of ON and OFF of the respective switch pair is enabled with reference to channel enabling data stored in the storage.

6. The driving circuit for a three-dimensional liquid crystal lens as defined in claim 1, wherein the driving circuit consists of three operation amplifiers which drive the high output signal, the low output signal and the common signal respectively.

7. The driving circuit for a three-dimensional liquid crystal lens as defined in claim 1, wherein the storage is a data register.
